(19) United States
(12) Patent Application Publication
(10) Pub. No.: US 2009/0119130 A1
(43) Pub. Date: May 7, 2009

(54) Method and apparatus for interpreting data

(76) Inventors: Zebadiah Kimmel, Morristown, NJ (US); Gerald Jay Sanders, Sonoma, CA (US)

Correspondence Address: MINTZ LEVIN COHN FERRIS GLOVSKY & POPEO, ONE FINANCIAL CENTER, BOSTON, MA, 02111, US

(21) Appl. No.: 11/982,881

(22) Filed: Nov. 5, 2007

(51) Int. Cl. G06F 19/00

(52) U.S. Cl. 705/3

(57) ABSTRACT

A system, method, and computer program for analyzing clinical data relating to a patient is provided. The system includes a computing device having a memory, a plurality of tables configured to be stored to be processed by the computing device, a plurality of modules configured to be executed by the computing device and further configured to interact with the plurality of tables. The modules are configured to process data obtained from a pool of data, wherein the pool of data includes raw clinical data relating to the patient and derived data based on internal processing. The plurality of tables is configured to store the results of execution by the modules. The results may undergo post-processing and then be outputted either to a user or to another electronic system.

### BACKGROUND OF THE INVENTION

### Field of the Invention

The present invention generally relates to methods and systems for analysis of medical data, including laboratory data, signs and symptoms, historical information about a patient, and so on. The present invention further relates to systems and methods for providing: 1) a differential diagnosis, i.e., a list of the most likely illnesses that match the known constellation of clinical data, and 2) a treatment plan or a best-practice workup, i.e., a list of next steps that should be taken, whether diagnostic or therapeutic.

### BACKGROUND OF THE INVENTION

Many conventional methods have been developed to provide a differential diagnosis based on a set of clinical data. Such conventional methods incorporate a variety of algorithms, including expert systems, neural networks, and Bayesian networks. A common failure of such methods is that they rank the differential diagnosis by a likelihood of occurrence, as opposed to the sequence in which hypotheses should be tackled. Another common failure of such methods is that they do not provide guidance regarding how to rule in, or rule out, any items listed within the differential diagnosis.

Several conventional methods have been developed to provide recommendations for a treatment plan or a best-practice workup, given a diagnosis in advance. Such conventional methods incorporate a wide variety of algorithms, making them difficult to categorize. A common failure of such methods is that they are problem-setting driven. This means that these conventional methods rely on a priori knowledge of a problem or a diagnosis (e.g., diabetes). This limits the applicability of these methods, and subsequent accuracy of treatment, to situations where the underlying problem itself has not yet been identified, or where multiple problems intersect at the same time. An example of such conventional systems and methods include a conventional system that provides best-practice recommendations for treating diabetes in the presence of renal failure, where this system cannot be invoked unless the system's user knows a priori that the patient has diabetes and renal failure. Another common failure of such conventional methods is that they require very particular and complete sets of data, resulting in failure if any portion of the required data is missing.

Some conventional methods are capable of determining a best-practice workup given only a set of clinical data. The results of these methods are typically fractured or incomplete and are not accompanied by an initial diagnosis. Such methods typically fail to keep up with the tremendous complexity of determining a best-practice workup, given the huge (and ever-changing) body of medical knowledge and the huge variety of concomitant clinical settings, signs, and symptoms. It is an object of the present invention to overcome these obstacles, describing a method to determine a best-practice workup, given only a set of clinical data (purely “data-driven”), with no assumptions as to completeness or prior diagnosis.

Conventional methods of automated interpretation of clinical data suffer from the following disadvantages, as they
rely on probabilistic or statistical methods which rank diagnoses in a manner that devalues the potential presence of unlikely but nonetheless severe illness;
rely on mathematical techniques and algorithms that in reality are mechanisms of convenience, unrelated to the problem domain;
provide only a differential diagnosis, while omitting the more important and useful task of providing a clinical workup (e.g., “what to do next”);
are unable to dynamically adjust to a wide variety of information in varying formats and from external systems, relying instead on fixed types of inputs, and are liable to ignore the existence of critical additional information;
are not data-driven, but rather rely on a priori knowledge of a diagnosis or condition;
do not deal with the combinatorial explosion generated by a multitude of input parameters; and,
are restricted to particular problem domains or “toy” problems.

Thus there is a need to provide a system and a method that can provide both a differential diagnosis and a best-practice workup given a set of clinical data, without any requirements as to completeness of the data, and without any need for a prior diagnosis.

### BRIEF DESCRIPTION OF THE INVENTION

Accordingly, it is an object of some embodiments of the present invention to provide a method and a system for providing a differential diagnosis and a best-practice workup given a set of clinical data, without any requirements as to completeness of the data, and without any need for a prior diagnosis.

It is an object of some embodiments of the present invention to provide a method and a system for providing, in its workup, both diagnostic and therapeutic recommendations.

It is an object of some embodiments of the present invention to provide a method and a system for dynamically adapting to input data, shifting recommendations to become more and more precise as more and more data is provided.

It is an object of some embodiments of the present invention to provide a method and a system for querying the user for additional relevant data that would assist in further refining the analysis.

It is an object of some embodiments of the present invention to provide a method and a system, which is highly extensible, so that additional knowledge may easily be added to the system.

It is an object of some embodiments of the present invention to provide a method and a system that runs efficiently, so that many patient records may be analyzed quickly in the background.

It is an object of some embodiments of the present invention to provide a method and a system that sends analyses directly into electronic medical records, when available.

It is an object of some of the embodiments of the present invention to provide a method and/or system which forwards medical orders or collections of orders directly into Computerized Physician Order Entry (CPOE) systems, when available.

It is an object of some of the embodiments of the present invention to provide a method and/or system which imports information directly from electronic medical record systems, electronic lab data systems, and other repositories of electronic clinical data.

It is an object of some embodiments of the present invention to provide a method and a system for an intuitive, compact user interface suitable for use by busy clinicians.

It is an object of some embodiments of the present invention to provide a method and a system that tailors output for multiple types of users, including insurers, clinicians, patients, and medical care facilities.

It is an object of some embodiments of the present invention to provide a method and a system that allows easy maintenance and updating over time, so that the knowledge encapsulated stays current.

In some embodiments, the present invention relates to a system for analyzing clinical data relating to a patient. The system includes a computing device having a memory, a plurality of tables configured to be stored and processed by the computing device, a plurality of modules configured to be executed by the computing device and further configured to interact with the plurality of tables. The modules are configured to process data obtained from a pool of data (wherein the pool of data includes raw clinical data relating to the patient), and generate derived data based on the processing. The modules are also configured to be executed using the derived data and/or raw data and to generate a result of such execution. The result of execution is provided to the plurality of tables. The plurality of tables is configured to store this result. The system further includes a collator configured to be executed by the computing device and further configured to generate output based on the result received from the plurality of tables.

In some embodiments, the present invention relates to a method for analyzing clinical data relating to a patient using a computing device having a memory for processing and storing a plurality of tables, and executing a plurality of modules configured to interact with the plurality of tables. The method includes processing data obtained from a pool of data, wherein the pool of data includes raw clinical data relating to the patient, generating derived data based on the processed data, executing at least one module to generate a result, providing the result to the plurality of tables, using the plurality of tables, storing the result, and generating output based on the result received from the plurality of tables.

In some embodiments, the present invention relates to a system for analyzing clinical data relating to a patient using a computing system having a memory, wherein the computing system processes and stores a plurality of tables, and executes a plurality of modules configured to interact with the plurality of tables. The system includes a means for processing data obtained from a pool of data, wherein the pool of data includes raw clinical data relating to the patient, a means for generating derived data based on the processing of data, a means for executing at least one module to generate a result, a means for providing the result to the plurality of tables, a means for storing the result in the plurality of tables, and a means for generating output based on the result received from the plurality of tables.

In some embodiments, the present invention relates to a computer program for analyzing clinical data relating to a patient, wherein the computer program is executable on a computing device having a memory. The computer program includes a plurality of tables and a plurality of modules configured to interact with the plurality of tables. The modules are configured to process data obtained from a pool of data—wherein the pool of data includes raw clinical data relating to the patient—and generate derived data based on the processing. The modules are executed using the derived data and/or raw data to generate a result and provide the result to the plurality of tables, wherein the plurality of tables are configured to store the result. The program further includes a collator configured to generate output based on the result received from the plurality of tables.

### BRIEF DESCRIPTION OF THE DRAWINGS

FIG. 1 is a block diagram illustrating an exemplary system for analyzing clinical data, according to some embodiments of the present invention.

FIG. 2 is a block diagram illustrating an exemplary pool of data, according to some embodiments of the present invention.

FIG. 3 is a block diagram illustrating exemplary raw clinical data, according to some embodiments of the present invention.

FIG. 4 is a block diagram illustrating exemplary derived data, according to some embodiments of the present invention.

FIG. 5 is a block diagram illustrating exemplary tables, according to some embodiments of the present invention.

FIG. 6 is a block diagram illustrating an exemplary structure of a table, according to some embodiments of the present invention.

FIG. 7 is a block diagram illustrating exemplary structure of a module, according to some embodiments of the present invention.

FIG. 8 is a flow chart illustrating exemplary execution of a module, according to some embodiments of the present invention.

FIG. 9 is a block diagram illustrating exemplary publish/subscribe list, according to some embodiments of the present invention.

FIG. 10 is a block diagram illustrating an exemplary structure of a trigger queue, according to some embodiments of the present invention.

FIG. 11 is a flow chart illustrating exemplary execution of a collator, according to some embodiments of the present invention.

FIG. 12 is a flow chart illustrating exemplary method for analyzing clinical data, according to some embodiments of the present invention.

FIG. 13 is a block diagram illustrating exemplary execution patterns of modules in the system for analyzing clinical data, according to some embodiments of the present invention.

FIG. 14 is a block diagram illustrating exemplary execution of a trigger, according to some embodiments of the present invention.

FIG. 15 is a block diagram illustrating an exemplary execution of a data request, according to some embodiments of the present invention.

FIG. 16 is a block diagram illustrating an exemplary automatic population of an order-entry system, according to some embodiments of the present invention.

FIG. 17 is a block diagram illustrating an exemplary finding output, according to some embodiments of the present invention.

FIG. 18 illustrates an exemplary collation of outputs of modules, after all modules have executed, according to some embodiments of the present invention.

FIG. 19 is a block diagram illustrating an exemplary module, configured to determine that the patient has an acid-base disorder, according to some embodiments of the present invention.

### DETAILED DESCRIPTION OF THE INVENTION

In some embodiments, the present invention relates to systems, methods, and computer programs for analyzing data, in particular clinical data relating to a patient, in order to determine a differential diagnosis (which can be a list of possible diagnoses) and treatment plan (or work-up) for the patient. More particularly, the present invention includes collections or classifications of modules that are capable of receiving raw clinical data, processing this data and/or subsets of such data, and generating derived data, and then, based on a combination of the clinical data (and/or its subsets) and derived data, determining a differential diagnosis and possible treatment plans or best-practice work-ups.

The present invention's systems, methods, and programs are configured to receive raw clinical data relating to a patient or an individual. For illustrative and non-limiting purposes, the term “raw” denotes clinical data, such as laboratory values, physical findings, prior medical history, test results, or other such data, that can be received from sources outside the present invention (such as medical laboratories, hospitals, physicians, other medical facilities, or any other sources). “Raw” data also includes certain types of data that may be built directly into the present invention—for example, ranges of normal laboratory values. In contrast, the term “derived” denotes data that is generated internally by the present invention by means of calculations, algorithms, or other processing; such processing can be performed on raw data, derived data, or both. As can be understood by one skilled in the art, the terms raw clinical data and derived data are not limited to the above definitions. Based on at least a portion of the raw data, derived data, and/or any combination thereof, a specific diagnosis and/or a treatment plan/work-up are generated for the patient.

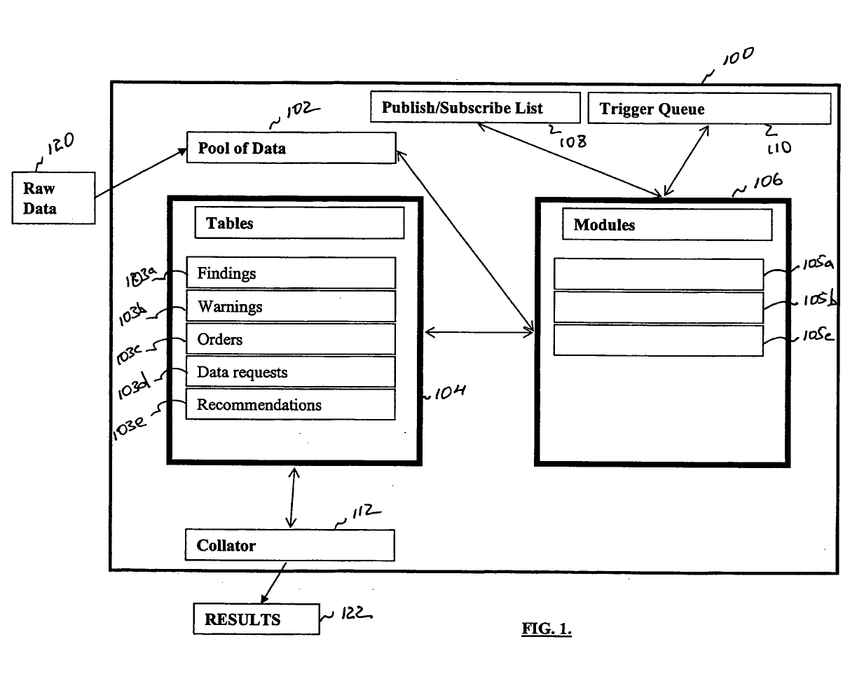

FIG. 1 is a block diagram illustrating exemplary system 100 for generating a diagnosis and a treatment plan for a patient, according to some embodiments of the present invention. In some embodiments, the present invention can be executed on a computing system (not shown in FIG. 1) that includes a processor, a memory, and other computing components. System 100 includes a pool of data 102, a collection of tables 104, a collection of modules 106, a publish/subscribe list 108, and trigger queue 110. In some embodiments, the system 100 receives its input in a form of a raw data 120. As stated above, the raw data 120 can include laboratory results, prior medical history, demographics, etc. The raw data 120 can be provided by the patient, hospitals, medical professionals, health insurance companies, patient's employers, government agencies, various automated systems, or from any other source that may have relevant information about the patient.

The raw data 120 is supplied to the pool of data 102 that is used for supplying data to the collection of modules 106. The collection of tables 104 includes a plurality of tables, such as: a findings table 103a, a warnings table 103b, an orders table 103c, a data requests table 103d, and a recommendations table 103e. As can be understood by one skilled in the art, tables 103 are not limited to those illustrated in FIG. 1.

The collection of tables 104 is configured to interact with a collection of modules 106. The modules 105(a, b, c) are configured to perform various calculations and functions, and to generate output and/or results. Such output/results can be fed back to the collection of tables 104 or data pool 102, provided to the publish/subscribe list 108, and/or provided to the trigger queue 110.

The collection of tables 104 also produce an output that is fed into the collator 112, which can perform post-processing of the output. The collator 112 is further configured to sort the output received from the collection of tables 104 and based on such sorting send the results out to the outside world. Additionally, the collator can format the output, eliminate redundancies, etc. Such results can include orders, findings, data requests, recommendations, and warnings. The results can be provided to the patient, medical professional, other automated programs, or any other individual, entity, program, etc. The results can be printed, displayed on the screen of a computer, or delivered in any form or shape desired. In some embodiments, these results can be broader than the eventual differential diagnosis generated by the system. An exemplary finding can be “this patient's clinical profile renders him/her ineligible for a clinical trial.”

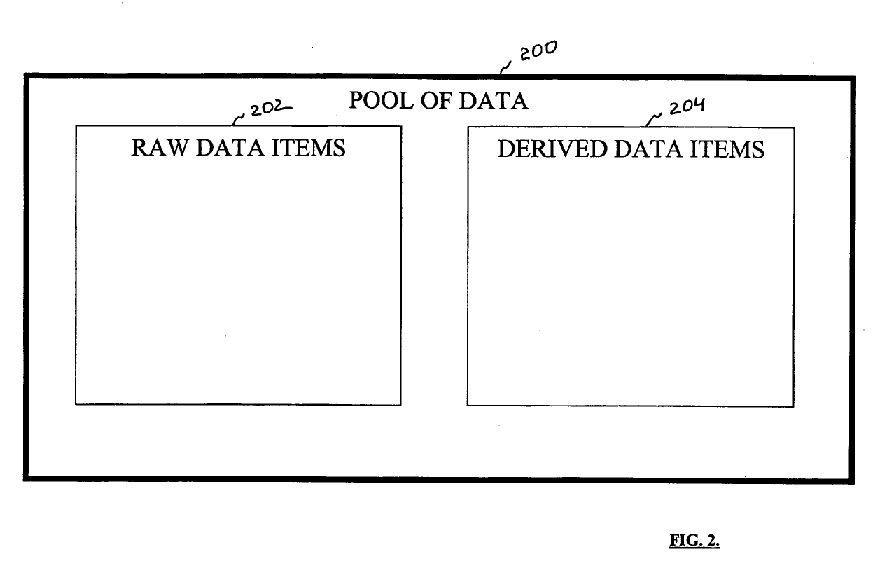

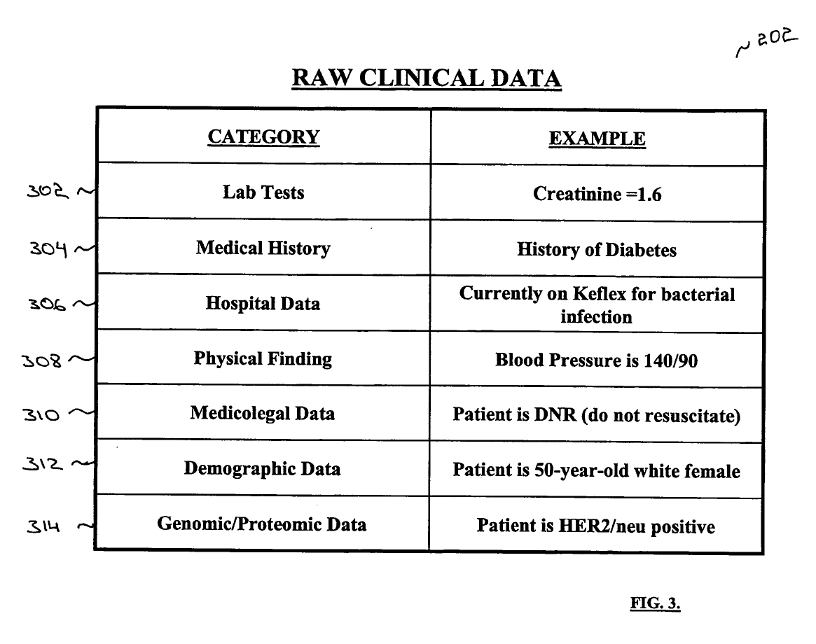

As illustrated in FIG. 2, the pool of data 200 includes raw data items 202 and derived data items 204. FIG. 3 further illustrates exemplary raw data items 202. In some embodiments, the pool of data can be initially populated with only the raw data items 202. As the present invention executes its modules, it generates derived data, which is added to the pool of data. As such, the pool of data 200 increases in size.

In some embodiments, the raw data items 202 can be subdivided into a plurality of categories, such as lab tests 302, medical history 304, hospital data 306, physical findings 308, medicolegal data 310, demographic data 312, and genomic data 314. The information/data 302-314 relates to a particular patient for which a diagnosis and a proposed treatment plan are being sought. The following are illustrative examples. The lab tests data 302 can include information that the patient's creatinine=1.6. The medical history data 304 can indicate that the patient has a history of diabetes. The hospital data 306 can indicate that the patient is currently on Keflex for bacterial infection. The physical findings data 308 can indicate that the patient's blood pressure is 140/90. The medicolegal data 310 can indicate that the patient has signed a do-not-resuscitate (“DNR”) consent form. The demographic data 312 can indicate that the patient is a 20-year-old white female. The genomic/proteomic data 314 can indicate that the patient is HER-2/neu positive. As can be understood by one skilled in the art, the present invention is not limited to the categories and/or information illustrated in FIG. 3. The present invention can gather any available data that will aid in the diagnosis and treatment plan or work-up determination for a particular patient.

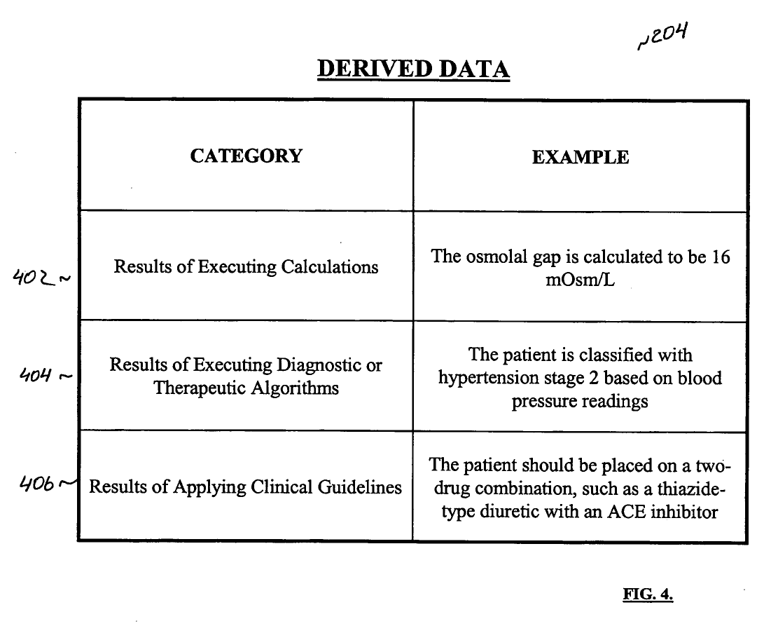

FIG. 4 illustrates exemplary categories of the derived data 204. Such exemplary categories include “results of executing calculations” 402, “results of executing diagnostic and/or therapeutic algorithms” 404, and “results of applying clinical guidelines” 406. As further illustrated in FIG. 4, the results 402 can include information that patient's osmolal gap is calculated to be 16 mOsm/L, the results 404 can include information that the patient is classified with hypertension stage 2 based on blood pressure readings, and the results 406 can include information that the patient should be placed on a two-drug combination, such as a thiazide-type diuretic with an ACE inhibitor. As can be understood by one skilled in the art, other categories of derived data are possible, such as statistical results, and are not limited to the three categories shown in FIG. 4.

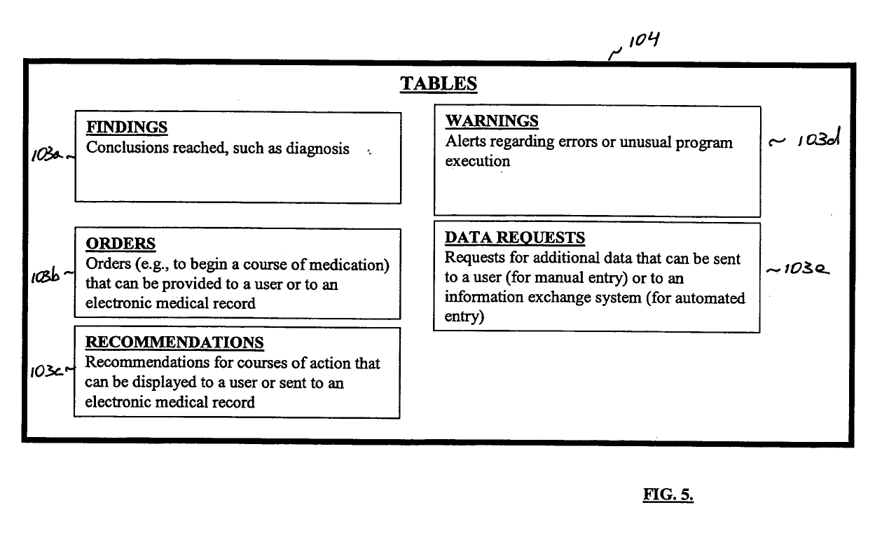

FIG. 5 illustrates an exemplary collection of tables 104. The findings table 103a is configured to determine the diagnosis and/or make certain conclusions based on the information available to the present invention.

The orders table 103b is configured to present and/or output specific orders for a treatment of the patient. For example, the orders table 103b can be configured to present an order that the patient should begin a specific treatment course.

The recommendations table 103c can be configured to present recommendations for courses of action to be taken with regard to the particular patient. The recommendations table 103c can be configured to perform a recommendation function based on the clinical data or at least one subset of the clinical data, derived data, or any combination thereof. For example, the recommendations table 103c can be configured to issue a recommendation stating: “Prescribe a beta blocker,” for a particular patient.

The warnings table 103d can be configured to issue alerts regarding errors or unusual program execution by the present invention. In some embodiments, the warnings table 103d can be configured to provide an indication to the user of the present invention's system 100 that the system 100 has obtained an abnormal result (e.g., assumption of a default value, or other out-of-the-ordinary signals).

The data requests table 103e can be configured to request additional data that can be sent to the user (e.g., patient, medical professional, etc.) for manual entry and/or to an information exchange system for automated entry. The data requests table 103e can be configured to request a specific additional data, such as raw clinical data 502 (or a subset of such clinical data), a derived data, or any combination thereof. For example, the data requests table 103e can be configured to issue a request for an albumin measurement in order to produce useful findings or recommendations. Such a request can be issued to the user of the system 100. Such a user can be a patient, a physician, a medical healthcare professional, or any other individual/system using the system 100. Alternately, such a request can be issued electronically to another electronic system; for example, an Electronic Medical Record (EMR), or Health Information Exchange (HIE) system. In some embodiments, the data request classification of code modules can generate a pop-up dialog on the user's computer screen, or an entry in an electronic medical record.

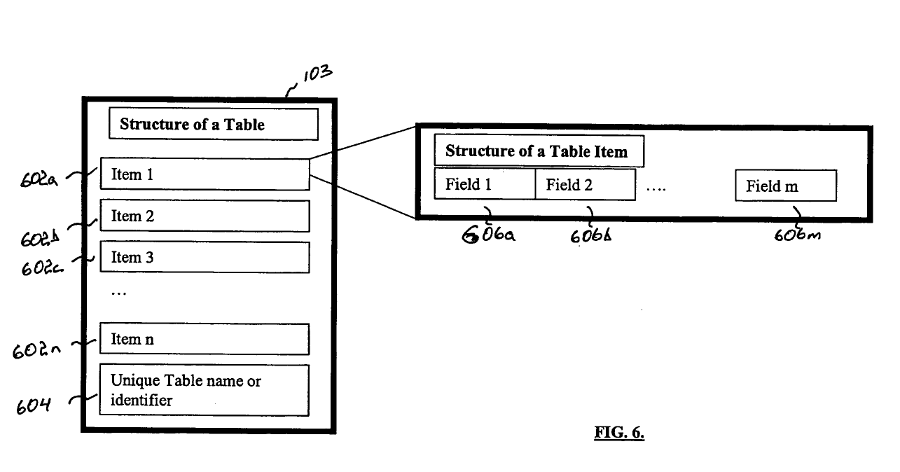

FIG. 6 is a block diagram illustrating an exemplary structure of a table 103 in the collection of tables 104. Each table 103 is configured to store information and/or data that can be ultimately provided as output results 122. As can be understood by one skilled in the art, the collection of tables 104 can contain at least one table 103 or no tables at all. In some embodiments, the collection of tables includes a plurality of items 602(a, b, c, . . . , n). Each item 602 can be configured to include zero or more fields 606(a, b, . . . , m). Each field 606 is configured to be a piece of information and/or data. Such data can be an encoding, a character, a string of text characters, a number, a string of numbers, a blob, and/or any other form information. As illustrated each table item 602 is configured to include m fields, where m≧0. Further, the table can be configured to include n items, where n≧0. In some embodiments, the table can include a unique table identifier that is configured to identify the specific table (recommendations, findings, data requests, etc.). Thus, each table 103 includes an n×m amount of information. As can be understood by one skilled in the art, other arrangements of tables 103 are possible.

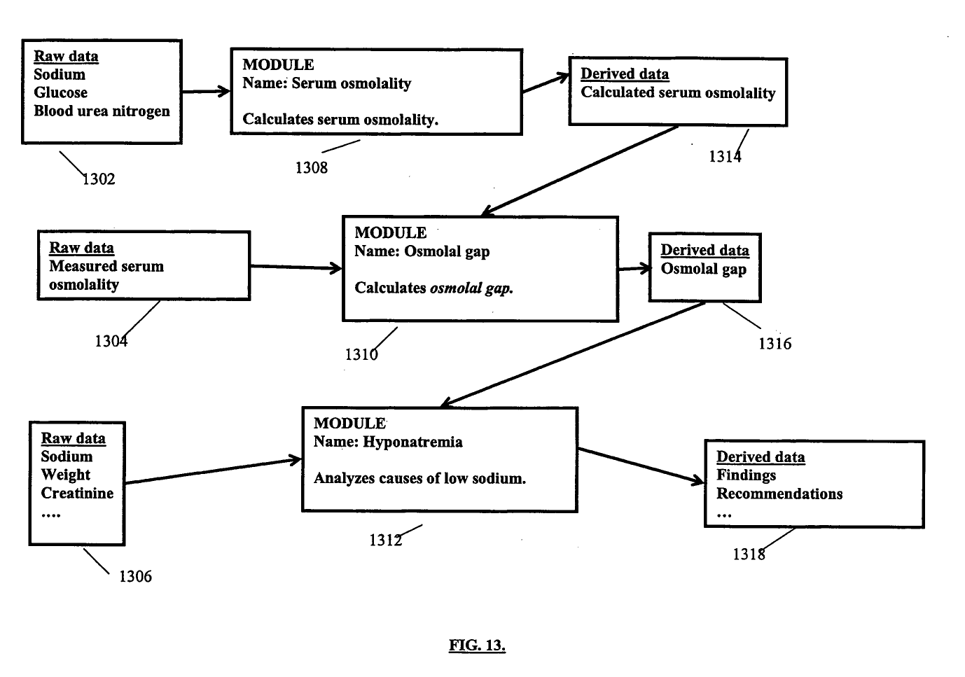

Referring back to FIG. 1, the system 100 further includes a collection of modules 106 having a plurality of modules 105 that are configured to perform various functions, including calculations, and output results to other constituents of the system. Examples of functions performed by the modules are illustrated in FIGS. 13-18 below.

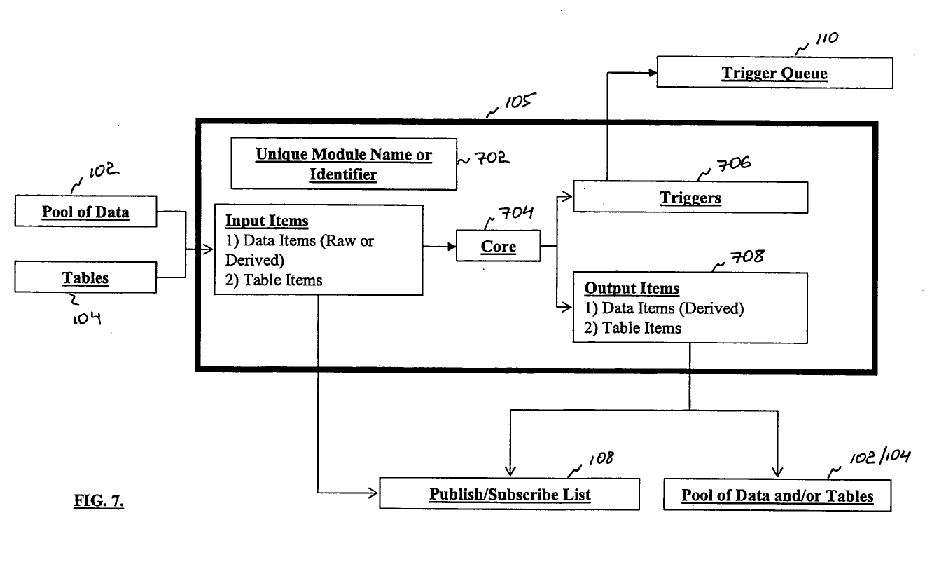

FIG. 7 illustrates an exemplary embodiment of components of a module 105. In some embodiments, the module 105 is identified by a unique module name or identifier 702 to other modules 105 and/or tables 103 in the collection of tables 104. The module 105 is configured to receive, as input, data that is drawn from the pool of data 102. Additionally, the module can receive, as input, information that is drawn from tables 103 in the collection of tables 104. As stated above, the information from the pool of data 102 and tables 103 can include raw clinical data, derived data, output results from tables, or any other data.

The module 105 is configured to include a core 704 for processing input data and generating a trigger (or a plurality of triggers) 706 and output items 708. The output items 708 can include derived data items and table items, as discussed above with regard to FIG. 7. The core of any particular module can be a block of computer code, a collection of rules (e.g., an expert system), and/or can be drawn from of a variety of other algorithms and/or systems.

The module 105 can be configured to send alerts to the publish/subscribe list 108 upon receipt of the input items from the pool of data 102 and/or table(s) 103. Such alerts can indicate that the module 105 has requested specific data, information, and other. This way, other modules 105 are made aware of the fact that this particular module 105 has requested information. If such information is not immediately available (e.g., needs to be provided by other module 105), other modules 105 can work to provide and/or request the information from other modules, the user, etc.

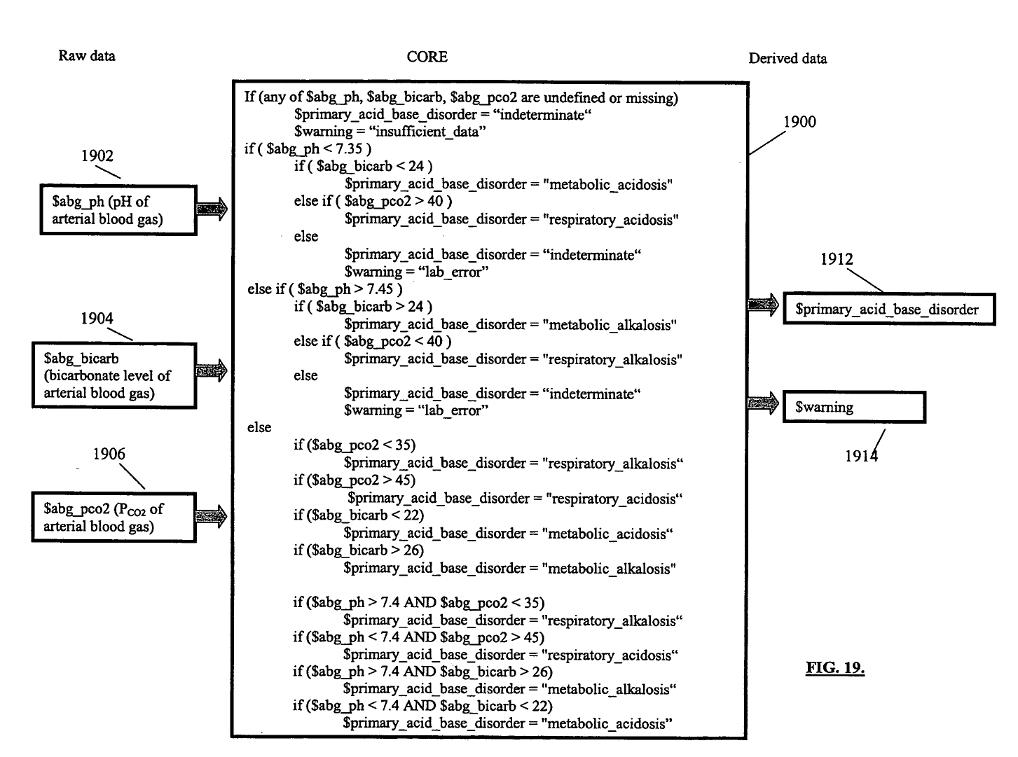

The core 704 can be configured to include a block of codes configured to be executed by a computer. Such computer can include a central processing unit (“CPU”), a memory, a hard drive, a RAM, and any other requisite components for execution of functions, which are provided to the Core 704. An exemplary Core 704 of the module 105 is illustrated in FIG. 19.

FIG. 19 is a block diagram illustrating an exemplary Core 1900 (which is similar to the Core 704 illustrated in FIG. 7) configured to determine that the patient has an acid-base disorder, according to some embodiments of the present invention. This particular example is shown in the computer language PHP by way of example; in general, a Core may be written in any computer language or construct, such as Java, XML, and/or others. To determine that the patient has an acid-base disorder, the Core 1900 employs a plurality of raw clinical data 1902, 1904, 1906 that can be obtained from a pool of data 102 (not shown in FIG. 19) by the Module that encloses the Core 1900. Raw clinical data 1902 represents the patient's pH. Raw clinical data 1904 represents the patient's bicarbonate concentration. Raw clinical data 1906 represents the patient's partial pressure of carbon dioxide. As can be understood by one skilled in the art, other raw clinical data relating to the patient can serve as inputs to the Core 1900. Additionally, derived data from other modules and/or tables can serve as input to the Core 1900.

In some embodiments, the Core 1900, based on the input data, can perform various manipulations indicated by the IF-THEN statements in the block showing the Core 1900. As a result of the manipulations performed by the Core 1900, derived data 1912 indicates that the patient has a primary acid-base disorder. Additionally, the Core 1900 can be configured to generate a warning 1914. As can be understood by one skilled in the art, the Core 1900 is not limited to the illustrated embodiments shown in FIG. 19 and can be configured to receive various other (raw or derived) data as input, as well as generate various other (derived) data as output. As can be further understood by one skilled in the art, the Core 1900 illustrates a particular example of a core within a module, but it is provided here for illustrative purposes only. It is not intended to limit the scope of the present invention.

Referring back to FIG. 7, the triggers 706 can be configured to activate other modules 105. The functionalities of other modules 105 can be activated either immediately or, in some embodiments, the modules can be activated after a certain time has passed, or when certain conditions are satisfied, by adding a trigger to the trigger queue 110 (also illustrated in FIG. 1). For example, future activation of the module 105 can depend on the execution of at least one other module that, in turn, provides prerequisite information/data to table(s) 103 to be used later by the module 105.

The output of the core 704 is configured to be added to the pool of data 102 in the form of derived data. The output of the core 704 can also be added as table items 702 to any of the tables 103.

Further, the module 105 can be further configured to place alerts to the publish/subscribe list 108 of the system 100. A “subscription” alert can be added to the publish/subscribe list 108 indicating that a particular input datum and/or data was requested by the module 105 but was unavailable when the module 105 executed. This way, other modules 105 can be made aware that a particular module 105 has requested specific input data, which can include raw clinical data, derived data, or any other information. Alternately, a “publication” alert can be added to the publish/subscribe list 108 indicating that a particular input datum and/or data was provided by the module 105. Such an alert tells other modules 105 that there are new information/data now available. Publish/subscribe schemes are common in the computer science literature and variations on the above will be familiar to one conversant in the art. In some embodiments, the publish and subscribe lists can be separated into two lists, rather than being combined into a single list as described herein.

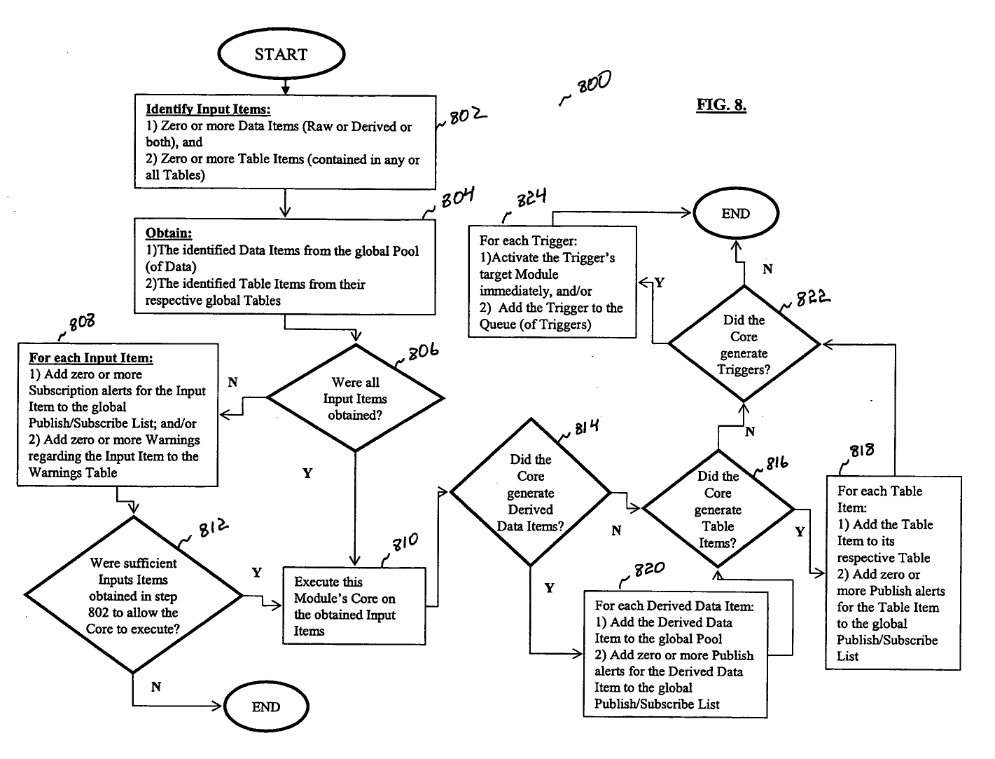

FIG. 8 illustrates an exemplary method 800 for execution of a module 105, according to some embodiments of the present invention. The method begins with step 802. In step 802, input items to the module 105 are identified. Such input items include (1) zero or more data items, such as raw clinical data/information and/or derived data; and/or (2) zero or more table items 602 from table(s) 103. The method proceeds to step 804.

In step 804, data items identified in step 802 are obtained from the pool of data 102 and table items identified in step 802 are obtained from the tables 104. The method then proceeds to decision step 806.

In step 806, the method 800 determines whether all items have been obtained, which are needed for execution of a particular module 105. If not, the method proceeds to step 808, wherein for each input item, the method 800 adds zero or more subscription alerts for the input item to the publish/subscribe list 108. Additionally, in some embodiments, the method 800 can also add zero or more warnings for the input items to the warnings table. Then, the method 800 proceeds to the decision step 812, where the method determines whether items obtained in step 804 are sufficient for the module(s) 105 and specifically the core to execute. If not, then the method 800 terminates.

If the method 800 determines that there is sufficient number of input items needed by module 105 to execute, the method 800 then proceeds to step 810, where module's core 704 executes based on the obtained input items.

If, in step 806, all items were obtained then the method 800 proceeds to step 810, wherein the module's core executes based on the obtained input items. The processing then proceeds to the decision step 814.

In step 814, the method 800 checks whether the core of the module 105 has generated derived data items. If so, then the processing proceeds to step 820. In step 820, each derived data item is added to the pool of data 102. Additionally, for each derived data item, an alert may be added to the publish/subscribe list 108 of the system 100. The alert indicates to other modules that the newly derived data is now available for use by the module(s) 105. The processing then proceeds to step 816.

If the core 704 did not generate derived data items (step 814), then the method proceeds to step 816, where the method 800 determines whether the module's core 704 generated new table items 602.

If, in step 816, the method 800 determines that the new table items were generated by the module's core 704, then the processing proceeds to step 818. In step 818, each new table item 602 is added to the respective table 103 (for example, recommendations table, data requests table, etc.). In some embodiments, an alert is also added to the publish/subscribe list 108. Such alert indicates that newly added item to the table(s) 103 is now available for use by the module(s) 105. The processing then proceeds to the decision step 822.

If, in step 816, it is determined that the module's core 704 did not generate any new table items 602, the processing proceeds to the decision step 822. In step 822, the method 800 determines whether or not the module's core generated triggers. If not, then the method 800 terminates.

If, in step 822, it is determined that the method 800 generated triggers, then the method proceeds to step 824. In step 824, for each newly-created trigger, its target module (e.g., calculation of osmolal gap (see FIG. 4)) may be activated immediately. In this case, the target module begins execution as soon as the current module completes. In some embodiments, if the execution of the target module is not immediately desired, the newly created trigger can be added to the list of triggers and placed in the trigger queue. In this case, target modules can be executed at a predetermined time, or when certain predetermined conditions are satisfied.

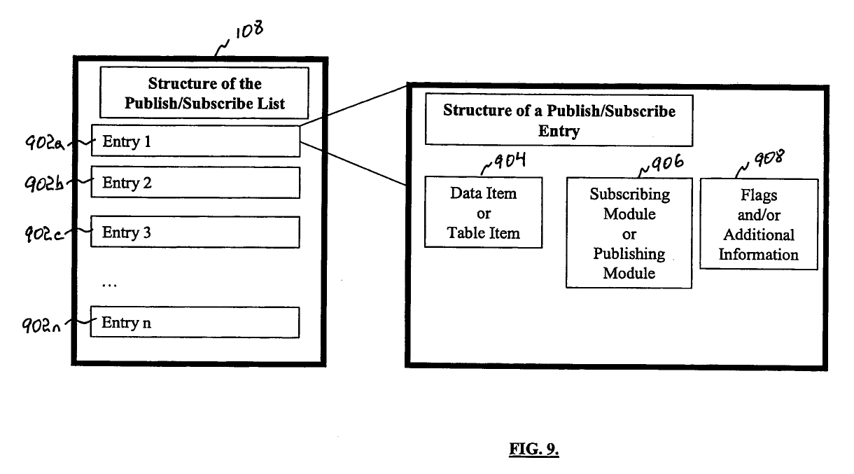

Referring to FIG. 9, an exemplary structure of the publish/subscribe list 108 is illustrated, according to some embodiments of the present invention. The publish/subscribe list 108 is configured to include a plurality of entries 902(a, b, c, . . . n). Each entry 902 is configured to correspond to specific input item(s), available data (whether clinical and/or derived), table item(s), or any other entry that may be available to modules 105 for use in performing their functions. The list 108 can also be configured to contain information about particular “subscription(s)” and/or “publication(s)” by modules 105, wherein such information can be made available to all modules 105.

As stated above, the modules 105 can be configured to “subscribe” to the publish/subscribe list 108. This means that the modules 105 can be alerted or executed, when particular data become available or when certain conditions become satisfied. By requesting information from the list 108, i.e., based on the “subscription” alert(s) and/or “publication” alert(s), the modules 105 request and have such information provided to them by other modules 105, data pool, table items, or any other sources. By adding items to the list 108 (i.e., publication and/or subscription alert(s)), the modules 105 are configured to add an entry and/or pointer to the list 108 that indicates the location and/or availability of information or data that is either requested or provided by modules 105 as a result of execution. The requested information may be obtained by a requesting module 105 by accessing the entry on the list 108 and communicating with the source of that information. The entries on the list 108 can also serve to notify modules 105 that have requested specific information/data that such information/data has become available and can be readily accessed. The list 108 can also provide information about events that can trigger the execution of particular modules. Examples of such triggering events include the determination of specific findings or the execution of specific modules. Some examples of triggering events are discussed below. The information in the list 108 may include data items, table items, or information about subscribing (information-requesting) and/or publishing (information-posting) modules 105. The list may also include alerts, flag(s), and/or any other information.

The data in each entry 902 is configured to include a name or an identifier 904 of a data item or a table item that is desired by the subscribing module 105 as well as a name or an identifier 906 of the subscribing module 105. As such, each entry 902 can be configured to include identifiers with which other modules 105 can locate necessary requested information. In some embodiments, the entry 902 can also be configured to include flag(s) and/or additional information in the structure 908.

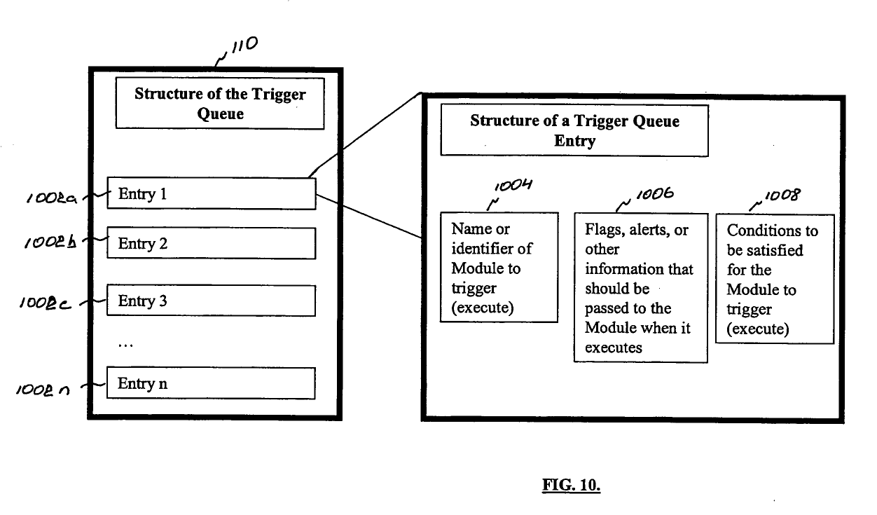

FIG. 10 illustrates an exemplary embodiment of the trigger queue 110, according to some embodiments of the present invention. The trigger queue 110 is configured to include a plurality of entries 1002(a, b, c, . . . n). Each entry 1002 is configured to correspond to specific trigger or a request for an input item(s), available data (whether clinical and/or derived), table item(s), or any other entry that may be requested by modules 105 for use in performing their functions and/or a trigger prompting execution of a specific module 105. Such execution of the specific module 105 can be immediate, i.e., as soon as the trigger is placed in the trigger queue 110, the core of the specific module 105 is executed, or can be postponed, i.e., the core of the specific module 105 can be executed at a later predetermined time. An example of later execution can be: execute module A when modules B and C have been executed, or execute module A when raw clinical data D and derived data E become available; or execute module A thirty minutes after receipt of the trigger into the trigger queue 110. As can be understood by one skilled in the art, other examples of postponed execution are possible. Also as can be understood by one skilled in the art, the trigger queue may be implemented within a variety of data structures including, but not limited to, a “queue” data structure as defined in the computer science literature.

The data in each entry 1002 is configured to include a name or identifier 1004 of a module 105 that is to be triggered (or which core is executed). As stated above, such triggering can be immediate or postponed. In some embodiments, the entry 1002 can also include flags, alerts or other information 1006 that can be passed to specifically selected modules 105 during their execution. Further, the entry 1002 can include information about conditions 1008 for triggering execution of a module and/or generating a trigger. As stated above, when a module 105 is triggered, specific information may be provided to the module pursuant to the module's execution. Similarly, for a module to generate a trigger, e.g., a request for a particular information, the module can determine that certain information required for its execution is missing and must be provided, thereby causing it to generate a trigger.

Referring back to FIG. 1, the collator 112 is configured to receive results of the tables 103. In some exemplary embodiments, such results can be findings, recommendations, requests for data, information, and/or any other input parameters, warnings, orders, or any other information. The collator 112 is configured to sort and collate such results before providing them to the user.

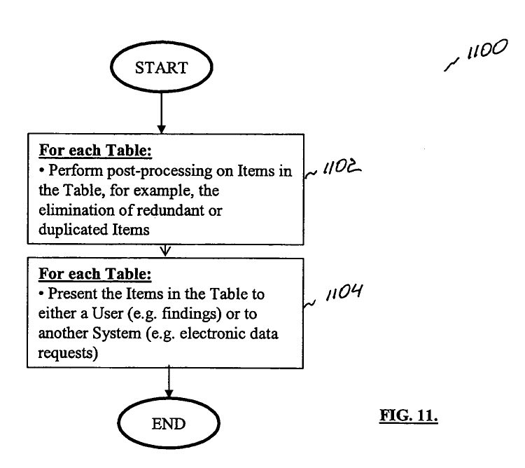

FIG. 11 is an exemplary flow chart illustrating method 1100 of operation of the collator 112, according to some embodiments of the present invention. In step 1102, the collator 112 is configured to eliminate redundant and/or duplicate items in any table 103 in the collection of tables 103. Such elimination can be done within a single table and/or across the entire collection 102 of all tables 103. Once the elimination is complete, the method 1100 proceeds to step 1104.

In step 1104, the collator 112 is configured to perform final processing (“post-processing”) on the information in the tables 104, and then present the results of the post-processing to the user (e.g., patient, medical professional, or any other authorized individual) and/or to another automated system. Such post-processing may include formatting, elimination of duplicates, language localization, and/or a variety of other functions. As can be understood by one skilled in the art, various methods of presenting information to users/automated systems are possible. Such results can be displayed in a spreadsheet, presentation, shown on a computer screen, transmitted electronically, etc.

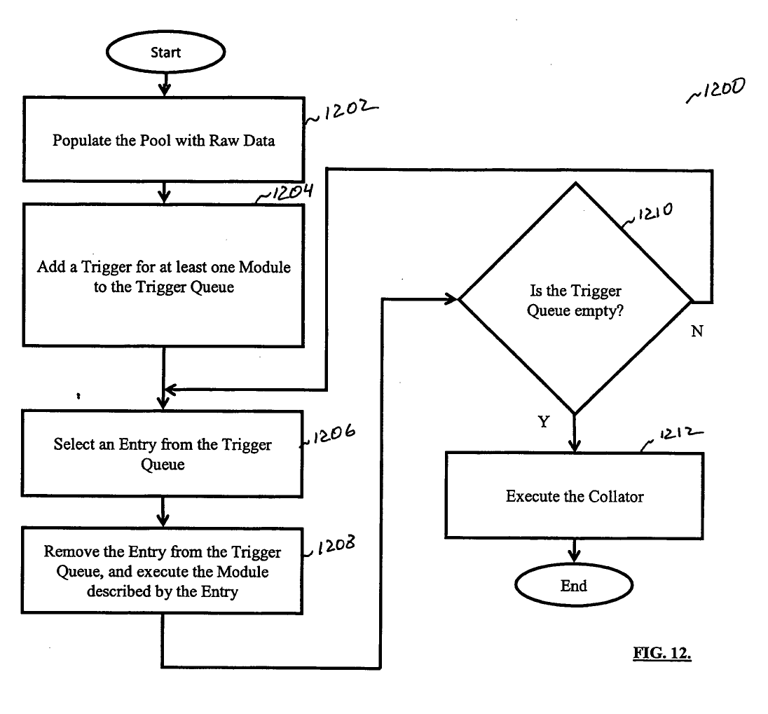

FIG. 12 is a flow chart illustrating exemplary method 1200 for analyzing clinical data, according to some embodiments of the present invention.

In step 1202, the method 1200 populates the pool of data 102 with a raw clinical data 120. This means that the raw clinical data 120 is configured to serve as an input to the system 100 and, in particular, to the pool of data 102.

Then, in step 1204, a trigger is added to the trigger queue 108, where the trigger corresponds to at least one module 105 in the collection of modules 104. This means that the trigger can be configured to identify at least one module 105 that is to be executed either immediately or at a later stage. As can be understood by one skilled in the art, more than one module 105 can correspond to the trigger placed in the trigger queue 108.

In step 1206, a specific entry in the trigger queue 108 is selected. This means that a particular module 105, corresponding to the selected entry, will be executed. The entry in the trigger queue 108 is removed and the module 105 that is identified in the entry is executed, as shown in step 1208.

The method 1200 then determines whether the trigger queue 108 is empty, i.e., whether all trigger entries have been selected and corresponding modules 105 have been executed. (See step 1210). If not, then the method 1200 proceeds back to step 1206 and repeats the procedure of selecting an entry from the trigger queue 108. Once the trigger queue 108 is empty, the method 1200 proceeds to step 1212, where the collator 112 is executed and the results are provided to the user.

The following discussion of execution of the modules 105 of the present invention is provided for illustrative, exemplary, and non-limiting purposes. This discussion is further provided to aid one skilled in the art in a better understanding of the present invention.

FIG. 13 is a block diagram illustrating exemplary execution patterns of the modules in the system of the present invention, according to some embodiments of the present invention. The execution patterns in FIG. 13 are used to determine that the patient has hyponatremia (low blood sodium). The modules in FIG. 13 are configured to use various raw clinical data as well as derived data. In the shown scenario, the pool of raw clinical data includes the patient's sodium, glucose, and blood urea nitrogen, as indicated by block 1302. Additionally, the raw clinical data includes the patient's measured serum osmolality, as indicated by block 1304, and the patient's sodium, weight, creatinine, and other data, as indicated by block 1306. The raw data of block 1302 is configured to serve as input to module 1308 that is further configured to calculate serum osmolality. Upon such calculation, the module 1308 generates a calculated serum osmolality. This derived data is indicated by block 1314. The derived data of block 1314 along with the raw clinical data in block 1304 are configured to serve as inputs to module 1310. The module 1310 is configured to calculate a value for osmolal gap. The module's 1310 derived data of osmolal gap is indicated in block 1316, as shown in FIG. 13. The derived data 1316 along with the raw clinical data 1306 are configured to serve as inputs to the module 1312, which analyzes causes of low sodium in the patient. Based on such analysis, the module 1312 generates findings and recommendations 1318. The findings and recommendations 1318 are placed into appropriate tables 104 and subsequently used by other modules to develop a differential diagnosis and treatment plan.

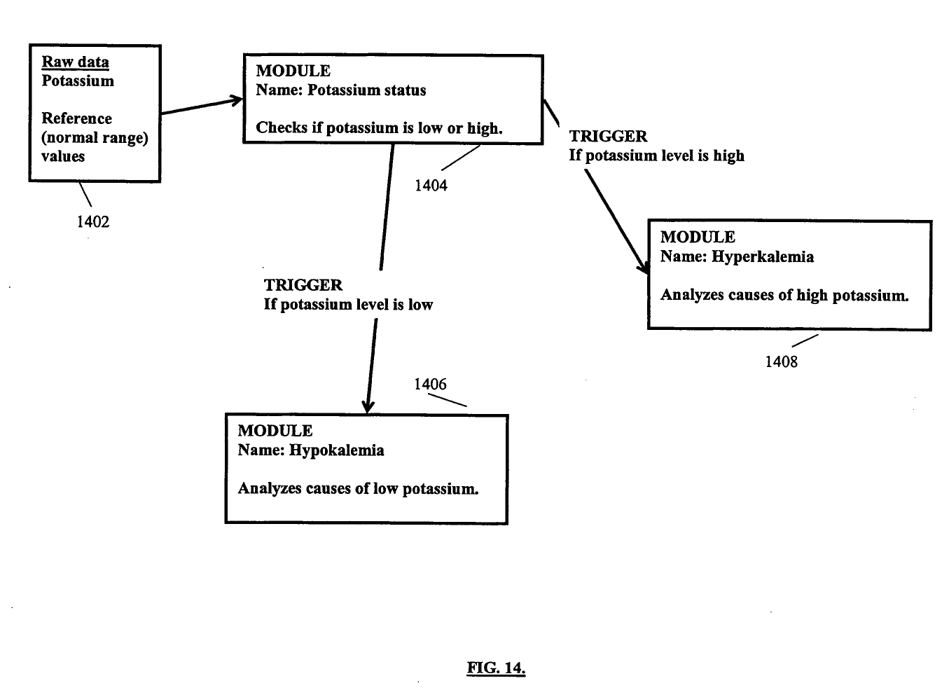

FIG. 14 is a block diagram illustrating an exemplary operation of a module that triggers further analysis of a patient's potassium levels, according to some embodiments of the present invention. In the shown embodiment, the patient's potassium test data (e.g., laboratory test results for potassium) appears as a raw clinical data 1402 that serves as input to a “potassium status” module 1404. The raw data 1402 may also include information about reference values (i.e., normal potassium high and low values). The module 1404 can be configured to determine whether the patient's potassium is at a high level or at a low level. In some embodiments, the module 1404 can be configured to compare the patient's potassium level to a predetermined potassium value that is encoded in the module 1404, or that is stored in the data pool 102. If the module 1404 determines that the patient's potassium level is higher than the predetermined potassium value, then the module 1404 triggers execution of a separate module 1408 which analyzes the causes of the patient's high potassium level. On the other hand, if the module 1408 determines that the patient's potassium level is low, then the module 1408 triggers execution of a module 1406 which analyzes the causes of the patient's low potassium level. As can be understood by one skilled in the art, the above description of the triggering module is not limited to the determination of potassium levels nor to the use of only two triggers. Other triggering events/triggers are possible and can be based on a specific patient's condition.

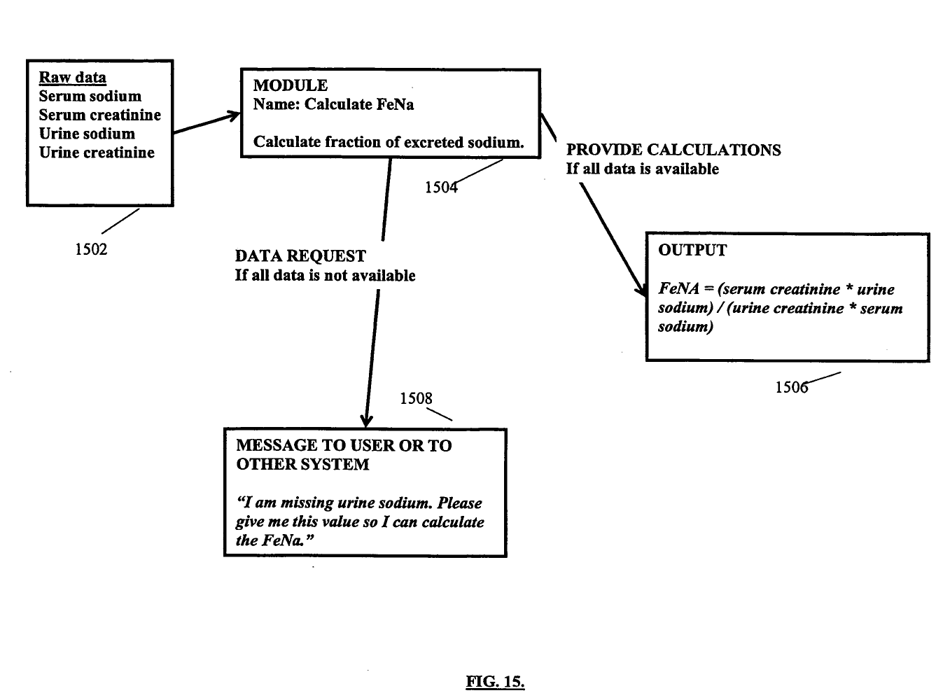

FIG. 15 is a block diagram illustrating an exemplary operation of a module that requests data related to the determination of a patient's fractional sodium excretion (“FeNa”) value, according to some embodiments of the present invention. In the shown embodiment of FIG. 15, the raw clinical data 1502 includes the patient's serum sodium, serum creatinine, urine sodium, and urine creatinine values. These values can be configured to serve as input to the module 1504 that is in turn configured to calculate the patient's FeNa value. The module 1504 can also be configured to determine whether all necessary data for the calculation of patient's FeNa values has been supplied to it. If all of the data was properly provided to the module 1504, then no additional data needs to be requested. As such, the FeNa value is calculated as (serum creatinine*urine sodium)/(urine creatinine*serum sodium), as indicated in output block 1506. This derived data may be further used by other modules and/or tables in calculations, analyses, determining diagnostic or treatment plan possibilities, etc. In the event that some of the raw clinical data 1502 was not provided to the module 1504, the module 1504 determines that some data is missing and that such data needs to be requested. The module 1504 (or any other module) generates a data request for the missing data (in this case, the value for urine sodium), as indicated by block 1508. The request may take the form of an electronic message to the user, an audio and/or video indication to the user, a pop-up screen on the user's computer, an electronic transmission to an electronic (non-human) system, or within any other means of communication.

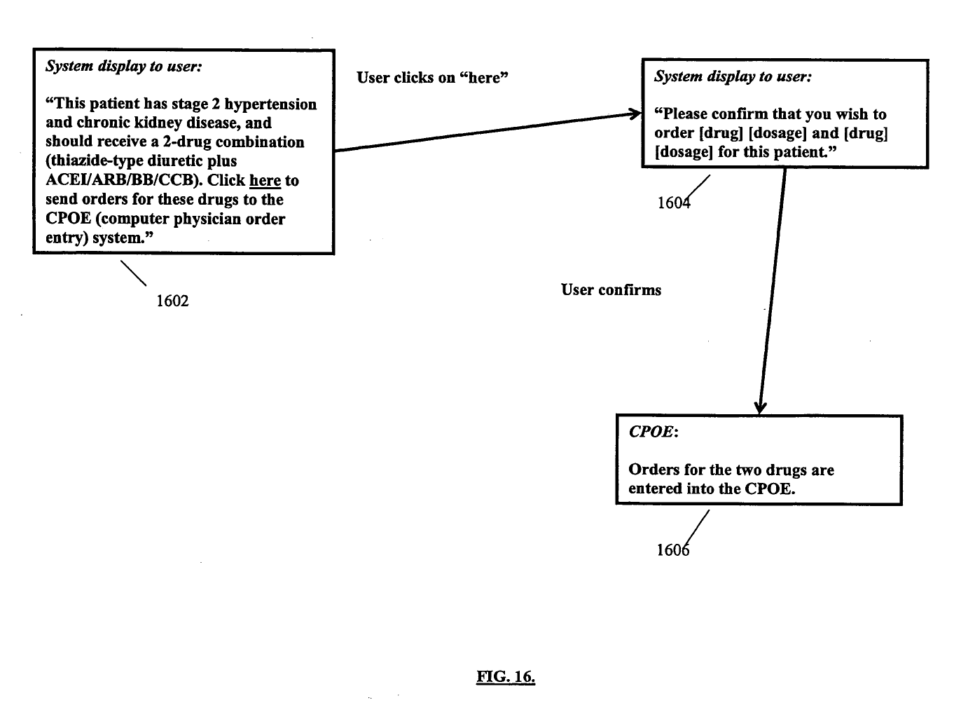

FIG. 16 is a block diagram illustrating exemplary recording of treatment procedures, according to some embodiments of the present invention. When the present system of the present invention has identified a particular best-practice therapeutic action based on the patient's condition, it allows the user to place that action, as an order, into the relevant order-entry system. As shown in FIG. 16, the system of the present invention can be configured to automatically enter orders by the system (or a physician, medical personnel, a health professional, or any other authorized user), into a computerized order-entry system, such as a computerized physician order-entry (“CPOE”). As shown in FIG. 16, in block 1602, the system of the present invention is configured to indicate to the user that the patient has a particular condition (stage 2 hypertension and chronic kidney disease), i.e., a diagnosis, and that the patient should receive certain drug treatment, i.e., a treatment plan/workup. The user may also be provided with an option to request such drugs (e.g., by clicking the word “Here” on the user's display). In some embodiments, once the user requests such drugs, the system of the present invention can be configured to request confirmation from the user that the user wishes to order the prescribed drugs, as indicated by block 1604. The confirmation can include the name(s) of the requested drug(s), the dosage(s) of the requested drug(s), and any other information (including patient information, patient insurance information, physician information, or any other relevant data). Once the user confirms his/her order, the system of the present invention proceeds to order the drugs, as indicated in block 1606. The system may also enter the information in the patient's medical records that can be created based on the analysis of raw clinical data, derived data, etc. As can be understood by one skilled in the art, other ways of fulfilling therapeutic action orders are possible.

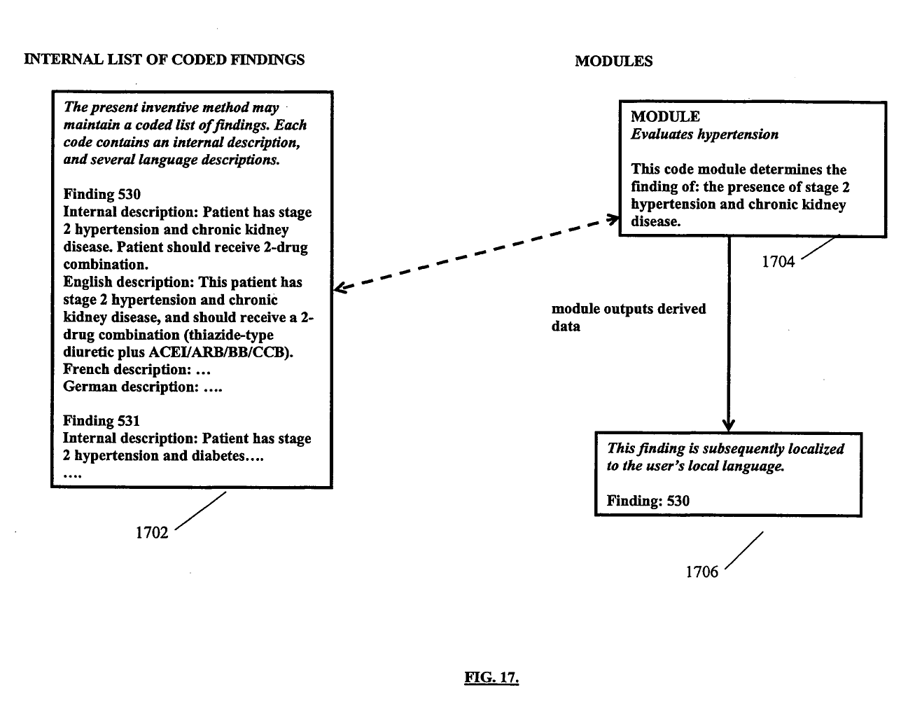

FIG. 17 is a block diagram illustrating an exemplary codification of outputs from individual modules, according to some embodiments of the present invention. In some embodiments, a “finding” can be considered as a conclusion reached by a particular module or a collection of modules. As illustrated in FIG. 17, each finding can be configured to be encoded, i.e., assigned a specific code that indicates a particular patient condition or any other information. Some advantages of the encoding of the findings include language localization, whereby the text describing any individual finding can be adapted for local users, and elimination of redundancy, whereby if multiple modules come up with the same finding, duplicate findings can be easily discarded. Additionally, findings can be configured to be flagged based on their priority and/or importance. For example, in some embodiments, a finding of high blood pressure can be considered more important than a finding that the patient does not have anemia.

As shown in FIG. 17, the system of the present invention can be configured to maintain all or some of the findings derived by the system in a coded format. For example, “Finding 530” may indicate that the patient has a stage 2 hypertension and chronic kidney disease and that the patient should receive a 2-drug combination treatment, as indicated in block 1702. Additionally, each finding can be encoded in different languages (English, German, French, etc.). The encoded findings can also provide a more detailed description that includes any additional information about the patient's particular health condition, description about the drugs, etc. Multiple findings (e.g., “Finding 531” in block 1702) may be listed one after the other for a particular patient. In block 1704, a module can be configured to evaluate patient's stage 2 hypertension and chronic kidney disease conditions. The findings of block 1704 can be codified in block 1706 into specific findings (e.g., “Finding 530”, “Finding 531”, etc.). Each coded finding can be then processed and added to an internal list of coded findings, as illustrated in block 1702. As can be understood by one skilled in the art, other ways of codifying findings are possible.

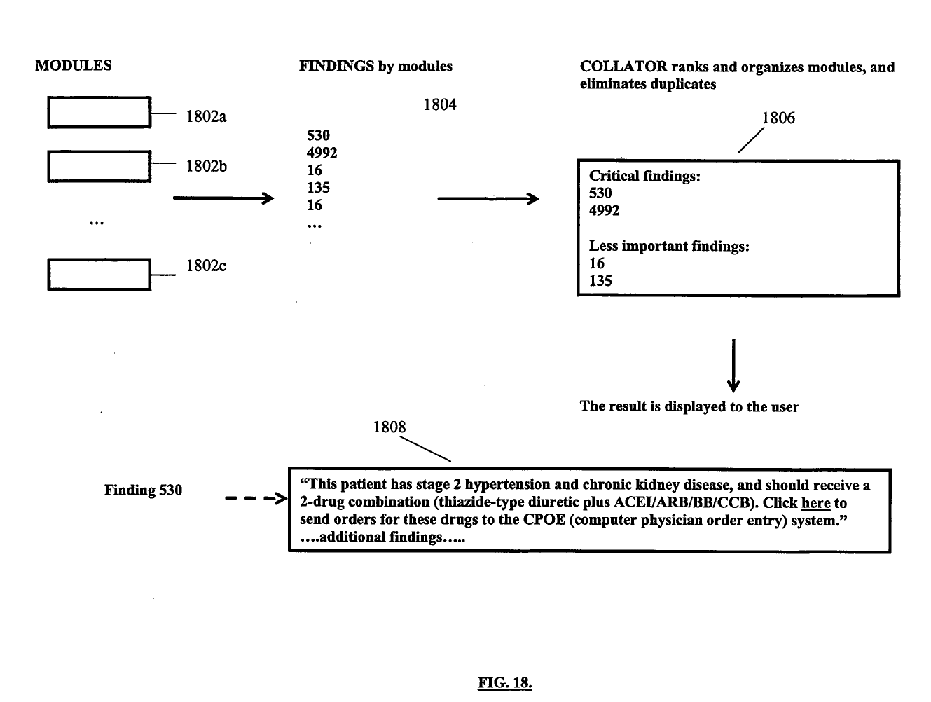

FIG. 18 is a block diagram illustrating an exemplary post-processing of coded findings by collating them and eliminating redundant findings, according to some embodiments of the present invention. As shown in FIG. 18, each module 1802(a, b, c) is configured to generate a specific finding or findings that can include diagnosis, treatment plan for that particular diagnosis, and/or any other pertinent information. Each finding is encoded, as illustrated by block 1804, in accordance with the procedure discussed in FIG. 8 above. As such, each finding is assigned a particular number (e.g., 530, 4992, 16, 135, and 16). The system of the present invention further includes a collator 1806 (similar to the collator 112 in FIG. 1) that is configured to organize the findings in order of importance as well as to eliminate any duplicate findings (e.g., duplicate appearance of finding “16” in the findings block 1804). In some embodiments, the collator 1806 can be configured to divide findings into “more critical findings” (such as 530 and 4992) and “less critical findings” (such as 16 and 135): in other words, to rank or prioritize findings according to criteria such as time urgency or severity of illness. Further, in some embodiments, the most important finding (e.g., 530) or findings can be configured to be displayed to the user, as indicated in block 1808. The user may be provided with the option of ordering an appropriate treatment plan, as indicated in FIG. 16 above. The user can be provided with any other options discussed above with regard to FIGS. 13-15 and 17.

Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other, unclaimed inventions are also contemplated. The applicant reserves the right to pursue such inventions in later claims.

What is claimed:

1. A system for analyzing clinical data relating to a patient, comprising:
a computing device having a memory;
a plurality of tables configured to be stored to be processed by said computing device;
a plurality of modules configured to be executed by said computing device and further configured to interact with said plurality of tables;
said modules are configured to
process data obtained from a pool of data, wherein said pool of data includes raw clinical data relating to the patient;
generate derived data based on said processing;
generate a result based on execution of at least one module in said modules using said derived data and/or raw clinical data;
provide said result to said plurality of tables;
said plurality of tables is configured to store said result.

2. The system according to claim 1, further comprising a collator configured to be executed by said computing device and further configured to generate output based on said result received from said plurality of tables.

3. The system according to claim 1, wherein said modules are further configured to request additional data based on said processing of said data obtained from said pool of data.

4. The system according to claim 3, wherein said modules are further configured to generate a trigger in order to cause execution of at least one other module.

5. The system according to claim 4, wherein said modules are further configured to add said requests for additional data and said triggers to a list of items distributed to other modules.

6. The system according to claim 5, wherein said modules are further configured to generate derived data based on said list of items.

7. The system according to claim 4, wherein said execution of said at least one other module is performed immediately.

8. The system according to claim 4, wherein said execution of said at least one other module is performed at a predetermined time and/or under predetermined conditions.

9. The system according to claim 1, wherein said plurality of tables include
a findings table configured to generate findings about the patient's condition based on said pool of data;
an orders table configured to generate proposed medical orders for the patient based on said findings and/or said pool of data;
a recommendations table configured to present a recommended course of action for the patient based on said findings and/or said pool of data;
a warnings table configured to generate alerts related to execution by said plurality of modules; and
a data requests table configured to generate requests for additional data related to the patient.

10. The system according to claim 9, wherein each table in said plurality of tables further comprises a plurality of items, wherein each item comprises a plurality of fields;
said plurality of fields is configured to contain information selected from a group consisting of findings, orders, recommendations, warnings, and data requests.

11. The system according to claim 2, wherein said collator is configured to:
perform post-processing on said tables; and
generate output based on said post-processing.

12. The system according to claim 1, wherein each said module is further configured to provide said derived data to said pool of data and said plurality of tables.

13. The system according to claim 1, wherein said clinical data is selected from a group consisting of: laboratory data, medical history, hospital data, physical findings, medicolegal data, demographic data, and genomic/proteomic data.

14. A method for analyzing clinical data relating to a patient using a computing device having a memory for processing and storing a plurality of tables, executing a plurality of modules configured to interact with the plurality of tables, the method comprising step of:
processing data obtained from a pool of data, wherein the pool of data includes raw clinical data relating to the patient;
generating derived data based on the processed data;
executing at least one module to generate a result;
providing the result to the plurality of tables;
using the plurality of tables, storing the result; and
generating output based on the stored result received from the plurality of tables.

15. The method according to claim 14, further comprising
requesting additional data based on said processing of the data obtained from the pool of data.

16. The method according to claim 15, further comprising
generating a trigger to trigger execution of at least one module.

17. The method according to claim 16, further comprising
adding requests for additional data and triggers to a list of items distributed to other modules.

18. The method according to claim 17, further comprising
generating derived data based on the list of items.

19. The system according to claim 16, wherein said generating a trigger step further comprises:
executing the at least one other module immediately.

20. The method according to claim 16, wherein said generating a trigger step further comprises:
executing the at least one module at a predetermined time and/or under predetermined conditions.

21. The method according to claim 14, further comprising:
generating
a finding for the patient based on the pool of data;
a proposed treatment plan for the patient based on the finding;
a recommended course of action for the patient based on the finding;
an alert related to execution by the at least one module; and
a request for additional data related to the patient.

22. A system for analyzing clinical data relating to a patient using a computing system having a memory, wherein the computing system processes and stores a plurality of tables, executes a plurality of modules configured to interact with the plurality of tables, comprising:
a means for processing data obtained from a pool of data, wherein said pool of data includes raw clinical data relating to the patient;
a means for generating derived data based on the processing of data;
a means for executing at least one module from the plurality of modules to generate a result;
a means for providing the result to the plurality of tables;
a means for storing the result; and
a means for generating output based on the stored result.

23. A computer program for analyzing clinical data relating to a patient, wherein the computer program is executable on a computing device having a memory, the computer program comprises:
a plurality of tables;
a plurality of modules configured to interact with said plurality of tables;
said modules are configured to
process data obtained from a pool of data, wherein said pool of data includes raw clinical data relating to the patient;
generate derived data based on said processing;
generate a result based on execution of at least one module in said modules using said derived data and/or raw clinical data;
provide said result to said plurality of tables;
said plurality of tables is configured to store said result;

24. The computer program according to claim 23, further comprising a collator configured to generate output based on said result received from said plurality of tables.
